(19) United States
(12) Patent Application Publication
(10) Pub. No.: US 2011/0017097 A1
(43) Pub. Date: Jan. 27, 2011

(54) ENERGY SAVING PAINT

(76) Inventor: Jean-Marie Ruckebusch, Douai (FR)

Correspondence Address: 3M INNOVATIVE PROPERTIES COMPANY, PO BOX 33427, ST. PAUL, MN, 55133-3427, US

(21) Appl. No.: 12/681,518

(22) PCT Filed: Sep. 30, 2008
(86) PCT No.: PCT/US08/78224

§ 371 Date: Oct. 18, 2010

(30) Foreign Application Priority Data
Oct. 4, 2007 (GB) 0719291.7

(51) Int. Cl. C09D 1/00; C08K 3/22; C09D 5/33

(52) U.S. Cl. 106/286.3; 106/286.5; 106/286.4; 524/430; 106/287.17

(57) ABSTRACT

A paint composition comprising white alumina, in particular white corundum, more particularly white fused corundum having a median particle size of at least 5.5 micrometers.

The present invention relates to paint compositions having desirable thermal infrared reflective characteristics.

### BACKGROUND

Energy costs can be reduced with paints which are thermal infrared (wavelength from about 2.5 to about 50 micrometers) reflective.

For example, US 2005/0215685 (Halmes) discloses an infrared reflective external wall paint (preferably of a dark color (i.e. of a shade tending towards black in comparison with other shades)) for painting one or more external vertical walls of a building where the paint contains at least one heat reflective metal oxide pigment. As metal oxide pigments US 2005/0215685 discloses the inorganic pigments disclosed in U.S. Pat. No. 6,174,360 (Sliwinski) and U.S. Pat. No. 6,454,848 (Sliwinski) which are solid solutions comprising a host component having a corundum-hematite crystal lattice structure which contain as a guest component one or more elements from the group consisting of aluminum, antimony, bismuth, boron, chrome, cobalt, gallium, indium, iron, lanthanum, lithium, magnesium, molybdenum, neodymium, nickel, niobium, silicon, tin, titanium, vanadium, and zinc. US 2005/0215685 referring to U.S. Pat. No. 6,616,744 (Sainz) also discloses as metal oxide pigments in which one or more metal alloys are incorporated as cations into a corundum-hematite crystal lattice structure; U.S. Pat. No. 6,616,744 disclosing metal alloys incorporated as cations in iron oxide having a hematite crystalline lattice structure and metal alloys containing cobalt, nickel, manganese, molybdenum and/or chromium.

U.S. Pat. No. 4,311,623 (Supcoe) discloses a moderately dark paint for use on exterior surfaces having infrared reflectance comprising aluminum powder.

### SUMMARY

It has been noted that paints which have any notable thermal infrared reflective characteristics are of a dark color and thus are disadvantageous for interior use. Furthermore, it has been found that “energy saving” paints of a light color (i.e. white or tending towards white) often show minimal thermal infrared reflective characteristics or in fact absorb thermal infrared radiation. Moreover it has been found that titanium dioxide, which is often used in paints including “energy savings” paints to achieve a light color, absorb thermal infrared radiation. This holds true for both forms of titanium dioxide (i.e., TiO₂ having an anatase or a rutile crystal structure).

Surprisingly it has been discovered that paint compositions including white alumina (in particular white corundum, more particularly white fused corundum) having a median particle size of at least 5.5 micrometers are advantageous for providing painted surfaces having desirable thermal infrared reflectivity.

Accordingly one aspect of the present disclosure is the provision of a paint composition comprising white alumina having a median particle size of at least 5.5 micrometers.

Such paint compositions allow for the provision of thermal infrared reflectivity characteristics approaching those observed for paints including elemental metal or metal alloy particulates, but without the necessity of adding such particulates. Accordingly paint compositions described are advantageously substantially free (e.g., less than 2 weight percent based on total solid content) or free of elemental metal and metal alloy particulates (e.g., powder or flakes). Additionally since white alumina (in particular white corundum, more particular white fused corundum) is white or colorless and often translucent, or even transparent, its use in paint compositions as described herein favorably allows for the provision of paint compositions of a light color while at the same time allowing for desirable thermal infrared reflectivity and associated energy savings.

Overall thermal IR reflectivity is further facilitated through relatively high concentrations of white alumina (in particular white corundum, more particularly white fused corundum).

Desirably paint compositions include said white alumina at a concentration of at least 35 weight percent based on total solid content; more desirably at least 47 weight percent, based on total solid content; even more desirably at least 52 weight percent, based on total solid content; and yet even more desirably at least 57 weight percent, based on total solid content. Most desirably the concentration of said white alumina relative to total solid content is as high as possible while having regard to other desired solid components of such paints compositions; such components may, for example, include pigments and binders as well as other conventional paint additives.

For additional opacity and/or whiteness (e.g., for interior use or use as a base paint) generally it is favorable to include a white pigment selected from the group consisting of zinc sulfide, lithopone, zinc oxide, zirconium (IV) oxide, bismuth oxychloride, white lead and mixtures thereof. The use of such pigments, in particular zinc sulfide, is particularly advantageous since their use does not substantially reduce, or in some cases does not reduce thermal infrared reflectivity characteristics achieved through the use of white alumina (in particular white corundum, more particularly white fused corundum) in paint compositions as described herein, thus allowing the application of high concentrations of such white pigments (e.g., greater than 40 weight percent, based on total solid content), for example, for very high opacity and/or hiding power. While titanium dioxide could be used to provide opacity and/or whiteness, to maintain desirable thermal infrared reflectivity for favorable energy savings, paint compositions described herein are desirably substantially free (e.g., less than 5 weight percent based on total solid content) of titanium dioxide, more desirably essentially free (e.g., less than 2 weight percent based on total solid content), and most desirably free of titanium dioxide.

This summary is not intended to describe each disclosed embodiment or every implementation in accordance with the present invention. Dependent claims disclose additional embodiments and many other novel advantages, features, and relationships will become apparent as this description proceeds.

### BRIEF DESCRIPTION OF FIGURES

FIG. 1 is a schematic representation of a gold coated integrating sphere, commercially available from SphereOptics, 27 rue des Clozeaux, 91440 Bures Sur Yvetter, externally attached to an FTIR spectrometer for measuring reflectance.

FIG. 2 represents the hemispherical reflectance spectra of white paint formulations comprising white fused corundum and of a standard white interior paint composition.

FIG. 3 shows the hemispherical reflectance spectra of paint formulations comprising white fused corundum and different white pigments or no white pigments.

FIG. 4 shows the hemispherical reflectance spectra of white paints comprising white fused corundum having different FEPA grit sizes and ZnS white pigment.

FIG. 5 represents the hemispherical reflectance spectra of white paint formulations comprising white fused corundum, ZnS white pigment and different binders.

FIG. 6 shows the hemispherical reflectance spectra of white paint formulations comprising different amounts of white fused corundum and ZnS white pigment.

FIG. 7 shows the energy consumption as a function of time of substrates painted with a white paint formulation comprising white fused corundum or with a white standard wall and ceiling paint.

### DETAILED DESCRIPTION

This disclosure presents the invention by way of representation and not limitation. It should be understood that numerous other modifications and embodiments can be devised by those skilled in the art which fall within the scope and spirit of the principles of this invention.

As mentioned above paint compositions comprising white alumina (in particular white corundum, more particularly fused white corundum) particles having a median particle size of at least 5.5 micrometers allow for the provision of painted surfaces having desirable thermal infrared reflectivity and accordingly energy savings (e.g., savings in heating costs).

As will be generally understood the term white is understood to mean white or colorless.

As will be generally understood the term alumina is understood to mean aluminum oxide, Al₂O₃, in any of its potential modifications (e.g., alpha-, beta-, and gamma-aluminum oxide). As used herein, the term, white alumina is understood to include aluminum oxides, Al₂O₃, that are white or colorless.

Preferred is white corundum, more preferred is white fused corundum.

As will be generally understood by the skilled reader, the term, corundum is understood to mean alpha-aluminum oxide (also known as alpha-alumina or α-Al₂O₃). As used herein, the term, white corundum is understood to mean corundum that is white or colorless.

Also as will be generally understood by the skilled reader, fused corundum (also known as fused alumina) is corundum made through a process including a fusing step where alumina is heated above its melting point, typically at approximately 2000° C. As used herein, the term, white fused corundum is understood to mean fused corundum that is white or colorless

As will be generally understood by the skilled reader, white corundum (e.g. white fused corundum) being white or colorless, unlike pink corundums or brown corundums, is generally essentially free (e.g., at most 0.02 weight %) or free of chromium oxide (Cr₂O₃), manganese oxide (Mn₂O₃) and titanium dioxide (TiO₂). Such metal oxides when present as guest or additive components at concentrations greater than 0.02 weight % in a solid solution with corundum aluminum oxide host structure generally provide coloration such as pink (red) or brown.

Favorably white corundum (e.g. white fused corundum) is of high purity (e.g., at least 95% Al₂O₃, more particularly at least 98.5% Al₂O₃ and most particularly at least 99.5% Al₂O₃). White corundums, in particular high purity white corundums, more particularly high purity white fused corundums, are commercially available from a number of potential vendors including Alcan Bauxite et Alumine, La Bâthie, France or Pacific Rundum Co. Ltd, Toyama, Japan. As generally and long known, commercial high purity white corundums (e.g. white fused corundums) typically include minimal amounts of Na₂O, SiO₂, Fe₂O₃, CaO and/or MgO. In terms of nominal chemical composition favorably white corundum (e.g. white fused corundum) is of a purity corresponding to Al₂O₃ 95% minimum; Na₂O 2% maximum: SiO₂ 2% maximum; Fe₂O₃ 0.5% maximum, CaO+MgO 0.4% maximum; more favorably Al₂O₃ 98.5% minimum; Na₂O 0.5% maximum: SiO₂ 0.7% maximum; Fe₂O₃ 0.1% maximum, CaO+MgO 0.2% maximum; and most favorably Al₂O₃ 99.5 weight % minimum; Na₂O 0.25% maximum: SiO₂ 0.06 weight %; Fe₂O₃ 0.08% maximum, CaO+MgO 0.1% maximum. The preceding generally corresponds to commercial specifications and/or purities of white corundum (e.g. white fused corundum), where all percentages mentioned are weight percents.

White corundum (e.g. white fused corundum) is preferably essentially free (e.g., at most 0.02 weight %) or free of antimony oxide, bismuth oxide, boron oxide, cobalt oxide, gallium oxide, indium oxide, lanthanum oxide, lithium oxide, molybdenum oxide, neodymium oxide, nickel oxide, niobium oxide, tin oxide, vanadium oxide and zinc oxide (e.g., as guest or additive components in a solid solution with corundum aluminum oxide host structure).

Thermal IR reflectivity can be advantageously further enhanced through the use of the white alumina (in particular white corundum, more particularly white fused corundum) having a median particle size of at least 8 micrometers, and yet further enhanced through the use of a median particle size of at least 10.5 micrometers. For desirably smooth painted surfaces and/or desired thermal IR reflectivity, generally the median particle size is at most 90 micrometers, more desirably at most 80 micrometers, even more desirably at most 70 micrometers and most desirably at most 60 micrometer. Said median particle size can be determined for example via sedimentation using a photo-sedimentometer, according to ISO 8486-1-2.

Overall thermal IR reflectivity may also be further facilitated the use of relatively high concentrations of white alumina (in particular white corundum, more particularly white fused corundum) particles relative to total solid content. Desirably paint compositions include white alumina at a concentration of at least 35 weight percent, more desirably at least 47 weight percent based on total solid content, even more desirably at least 52 weight percent based on total solid content, yet even more desirably at least 57 weight percent based on total solid content. As mentioned above, most desirably the concentration of white alumina relative to total solid content is as high as possible while having regard to other desired solid components of such paints compositions; such components may include pigments and binders as well as other conventional paint additives. Generally paint compositions described herein will have at most 90 weight percent based on total solid content of white alumina, in particular at most 85 weight percent based on total solid content and more particularly at most 80 weight percent based on total solid content.

As mentioned above, for additional opacity and/or whiteness (e.g., for interior use or use as a base paint) generally it is favorable to include a white pigment in paint compositions described herein. The white pigment is selected from the group consisting of zinc sulfide, lithopone, zinc oxide, zirconium (IV) oxide, bismuth oxychloride, white lead, and mixtures thereof. Zinc sulfide is preferred. White pigment zinc sulfide is commercially available for example from Sachtleben, Duisberg, Germany under the trade designation SACHTOLITH L. Favorably, the concentration of such a white pigment is at least 5 weight percent based on total solid content and more favorably at least 10 weight percent based on total solid content and even more favorably at least 13 weight percent based on total solid content. For high hiding power over for example black substrates, the concentration of white pigment is desirably at least 20 weight percent based on total solid content, and more desirably at least 24 weight percent based on total solid content. For very high opacity and/or hiding power, paint compositions can for example include greater than 40 weight percent based on total solid content (if not more) of such a white pigment. However for typical opacity and/or whiteness desires and/or needs, compositions generally, favorably comprise at most 40 weight percent based on total solid content and more favorably 35 weight percent based on total solid content. Median particle size of white pigment is favorably at most 1 micrometer, more favorably at most 0.5 micrometer, and even more favorably at most 0.4 micrometer, most favorably in the range from 0.2 to 0.3 micrometer.

Paint compositions described herein may, if desired, include a colored pigment (i.e., non-white pigment) to impart color (i.e., a color that is not white). Such a colored pigment may be included in addition to white pigment(s) described herein or used instead of white pigment(s) described herein. The former option is generally preferred, where generally, desired opacity and/or hiding power is achieved through the use of white pigment(s) described above, while a colored pigment or a mixture of colored pigments is added to provide the desired and/or needed color, where the selection and concentration(s) of colored pigment(s) to achieve to a particular color is generally known in the art. Concentration of colored pigment(s), if used, will be typically low, generally at most 5 weight percent based on the total solid content of the paint composition (although the inclusion of higher amount is not excluded). To maintain advantageous thermal IR reflectivity imparted through the use of white alumina (in particular white corundum, more particularly white fused corundum) as described herein, if a colored pigment is used, desirably the colored pigment is a colored metal oxide pigment, in particular an infrared reflective colored metal oxide pigment. Such colored pigments are described for example in U.S. Pat. Nos. 6,174,360 (Sliwinski), 6,454,848 (Sliwinski) and 6,616,744 (Sainz), and are available on the market from Ferro Corporation, Cleveland, Ohio, U.S.A., under the trade designation COOL COLORS & ECLIPSE pigments, with examples including Product Nos. V-13810 Red (Red Iron oxide); V-9250 Blue (Cobalt Aluminate Blue Spinel); V-9416 Yellow (Nickel-Antimony Titanium Yellow rutile); V-799 Black (chromium Green-Black Modified).

Desirably paint compositions further comprise a binder. Typically the binder is present at concentration of at least 5 weight percent based on total solid content and more typically at least 10 weight percent based on total solid content. Typically the binder is present at concentration of at most 30 weight percent based on total solid content, more typically at most 25 weight percent based on total solid content, and even more typically at most 20 weight percent based on total solid content. Suitable binders include acrylic resins, styrene-acrylic copolymers, styrene-(meth)acrylic acid copolymers, ethylene-vinylacetate copolymers and mixtures thereof. Particularly desired binders include acrylic resins and mixtures of acrylic resins. Water-dispersible binders are particularly desirable, in particular water-dispersible binders made of acrylic resin(s).

Paint compositions may further comprise other conventional paint additives routinely used in the art (e.g., defoamers, antifoams, thickening agents, leveling agents, wetting agents, dispersing agents, anti-settling agents, stabilizers, light stabilizers, anti-flocculating agents, texture-improving agents, antimicrobial agents and/or fungicides). Appropriate concentration of such additives may be easily determined by those skilled in the art as to provide desired properties of paint composition and/or desired properties of painted surface.

Paint compositions described herein suitably further comprise a vehicle for painting, the vehicle being water, a water-based liquid or an organic-based liquid. Organic-based liquids may be solvent-based, oil-based, or liquefied propellant based liquids. Such paint vehicles are well known in the art. Preferred vehicles include water and water-based liquids. In alternative embodiments paint compositions described herein may be provided in a form of a concentrate (e.g., in the form of a dry mixture, a paste or concentrated liquid) suitable for dispersion in a painting vehicle.

Paint compositions described herein, besides being particularly suitable for interior use as indicated above, are also advantageous for use in treating exterior surfaces, such as exterior building surfaces, e.g. exterior walls or roofs (e.g. metal roofs) or domes or components thereof.

### EXAMPLES

All percentages used in the examples are by weight, unless otherwise specified.

### A. TEST METHODS AND PROCEDURES

### 1. Measurement of Reflectance

The reflectance was measured in accordance with EN 12898 standard (“Glass in building—Determination of the emissivity”, January 2001), using following specifications and modifications:

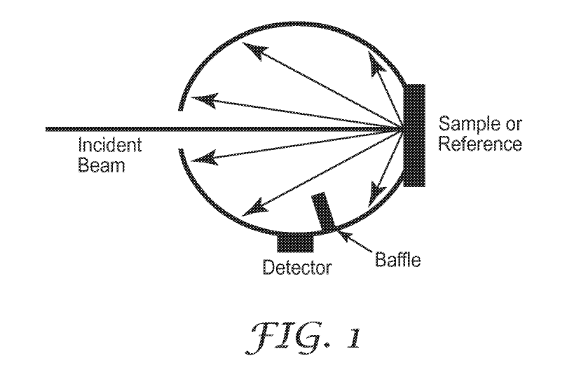

The reflectance was measured using an ABB BOMEM MB-154S FTIR spectrometer, available from ABB, Rueil-Malmaison, France, equipped with an external 50 mm gold coated integrating sphere, commercially available from SphereOptics, 27 rue des Clozeaux, 91440 Bures Sur Yvetter, France and schematically represented in FIG. 1.

Since the measurements were made with an integrating sphere, the reflectance was referred to as hemispherical reflectance. A gold mirror, with a known hemispherical reflectance spectrum, and supplied together with the gold coated integrating sphere, was used as reference. The wavelength range allowed for measurements was between 2.5 and 16.5 micrometers.

The hemispherical reflectance of a sample Rₙ (λi) at each wavelength λi, can be represented by following equation:

$${R}_{n} ( {λ}_{i} ) = \frac{E - {E}_{0}}{{E}_{st} - {E}_{0}} \cdot {R}_{n , st} ( {λ}_{i} )$$

Wherein E represents the instrument reading when a sample is placed on the sample support of the integrating sphere, Eₛₜ represents the instrument reading with the reference mirror, E₀ represents the instrument reading without placing anything on the sample support and R_{n,st} (λi) represents the hemispherical reflectance of the reference mirror at the wavelength λi.

The recorded values were an average of 20 measurements done per sample.

The total hemispherical reflectance Rₙ was determined from the spectral reflectance curve by taking the mathematical average of hemispherical reflectance Rₙ (λi), measured at 18 wavelengths (λi) as indicated in Table, below. The total hemispherical reflectance Rₙ was calculated according to following equation:

$$Rn = 1 / 18 {\sum }_{i = 1}^{i = 18} Rn ( λ i )$$

TABLE
(λi) values used in the calculation of total hemispherical reflectance Rₙ:

| Ordinal | Wavelength (λi) |
|---|---|
| number i | μm |
| 1 | 5.5 |
| 2 | 6.7 |
| 3 | 7.4 |
| 4 | 8.1 |
| 5 | 8.6 |
| 6 | 9.2 |
| 7 | 9.7 |
| 8 | 10.2 |
| 9 | 10.7 |
| 10 | 11.3 |
| 11 | 11.8 |
| 12 | 12.4 |
| 13 | 12.9 |
| 14 | 13.5 |
| 15 | 14.2 |
| 16 | 14.8 |
| 17 | 15.6 |
| 18 | 16.3 |

### 2. Determination of Energy Saving

The actual energy saving obtained with a paint formulation according to the present invention was determined by comparing the energy consumption of two 2001 empty containers, one having the 5 inner surfaces painted with a paint according to the present invention and one having the 5 inner surfaces painted with a standard wall & ceiling paint. The energy consumption while heating the containers was measured using following test equipment:

Two pieces of expanded polystyrene foam board with a size greater than the size of the containers served as ground area of the testing equipment. To each board was attached an electrical heating resistance. To monitor the temperature inside the empty containers, two NTC high precision thermistors, obtained under the trade designation SEMITEC 103AT-2, from Semitec USA corp., were placed in the centre of 2 metallic painted black spheres having a diameter of 15 cm. The spheres were placed on the boards, such that they were in the center of the volume of the empty containers after those were placed on the boards. Each of the NTC thermistor probes was further connected to its own thermostat, obtained under the trade designation INVENSYS WM 901, from Invensys PLC, London, UK, that regulated the inner temperature of each container after the containers had been placed on the boards, covering the equipment. This testing equipment was then placed in a refrigerated room, held at a temperature of 0° C. The heating system was switched on to achieve an average temperature of 16° C. inside the containers and the energy consumption was recorded with two individual standard ordinary energy counters. The energy consumption was recorded (Watt·hour) over a time period of 40 hours. The overall energy saving was calculated from the slopes of the curves (obtained by linear regression) using following equation:

% energy saving is =100×(slope standard paint−slope 3M paint)/slope standard paint)

### 3. Evaluation of Whiteness of Paint

The whiteness of paints was evaluated according to ISO 2814. Paint coatings having a wet coating thickness of 150 micrometers were made on white and black Leneta card. After drying at room temperature for 24 hours, a dry coating thickness of 70μ was obtained. The luminance (L*) of the paint in the visible band was measured according to ISO 2814. A value of 100 is indicative of a pure white coating, whereas a value of 0 refers to a black coating. The contrast ratio or opacity was recorded in %.

### B. LIST OF MATERIALS USED

TABLE 1

| | Product | |
|---|---|---|
| Abbreviation | (trade designation provided in capital letters) | Availability |
| Al₂O₃ | White fused corundum, CRISTALBA | Alcan Bauxite et Alumine, |
| | CAHP; nominal composition 99.8% | La Bâthie, France |
| | Al₂O₃, 0.11% Na₂O, 0.01% SiO₂, 0.02% | |
| | Fe₂O₃, and 0.02% CaO + MgO. | |
| | Different grades in accordance to FEPA | |
| | grit size (specified according to FEPA | |
| | 42-F-1984 standard) were used as | |
| | summarized in Table 2 | |

Pigments

| | | |
|---|---|---|
| ZnS | Zinc Sulphide, SACHTOLITH L, >98% | Sachtleben, Duisburg, |
| | purity; Sieve residue (Mesh gauge 45 μm) | Germany |
| | <0.02% | |
| TiO₂ | KRONOS 2059, Rutile TiO₂; | Kronos International Inc., |
| | ≧93.5% content | Leverkusen, Germany |

Binder

| | | |
|---|---|---|
| Binder 1 | CRAYMUL 2502; water based acrylic | Cray Valley, Paris, France |
| | resin. Solids content 47% (ISO 976); | |
| | viscosity 500 mPa · s (ISO 2555 | |
| | Brookfield Viscometer) | |
| Binder 2 | CRAYMUL 2126; high solids water | Cray Valley, Paris, France |
| | based acrylic resin; solids content 60% | |
| | (ISO976); viscosity 4,000 mPa · s (ISO | |
| | 2555 Brookfield Viscometer) | |
| Binder 3 | CRAYMUL 2100; water based styrene- | Cray Valley, Paris, France |
| | acrylic resin; solids content 50% (ISO | |
| | 976); viscosity 1,800 mPa · s (ISO 2555 | |
| | Brookfield Viscometer) | |
| Binder 4 | MOWILITH LDM 1871; water based | Celanese Emulsions, |
| | dispersion of Ethylene-vinylacetate | GmbH, Frankfurt-am- |
| | copolymer. Solids content 53% (ISO | Main, Germany |
| | 3251); viscosity 2,500 mPa · s (ISO 2555 | |
| | Brookfield Viscometer) | |
| Binder 5 | MOWILITH LDM 7671; water based | Celanese Emulsions, |
| | dispersion of Styrene-(meth)acrylic acid | GmbH, Frankfurt-am- |
| | copolymer. Solids content 50% (ISO | Main, Germany |
| | 1625); viscosity 6,500 mPa · s (ISO 2555 | |
| | Brookfield Viscometer) | |

Additives

| | | |
|---|---|---|
| Defoamer | BYK 1610, mineral-oil free, modified | BYK, Wesel, Germany |
| | polysiloxane based defoamer emulsion | |
| | (17% solids) | |
| T/L | COAPUR 830W Polyurethane | Coatex, Lyon, France |
| | thickener or levelling agent; solvent | |
| | water; 30% solids content | |
| W/D-1 | COATEX BR3 wetting and dispersing | Coatex, Lyon, France |
| | agent; Potassium salt of an acrylate- | |
| | copolymers; 40% in water | |
| W/D-2 | COATES P90 Wetting and dispersing | Coatex, Lyon, France |
| | agent; Ammonium polyacrylate; 40% in | |
| | water | |
| CaCO₃ | CaCO₃, DURCAL 10 (10 μm) | Omya, France |

TABLE 2
Grades of white fused corundum Al₂O₃ used in terms of grit size; size
determined according to FEPA 42-F-1984 standard

| FEPA Grit Size | 50% min in size range (μm) |
|---|---|
| F240 | 42.5-46.5 |
| F280 | 35.0-38.0 |
| F320 | 27.7-30.7 |
| F360 | 21.3-24.3 |
| F400 | 16.3-18.3 |
| F500 | 11.8-13.8 |
| F600 | 8.3-10.3 |
| F800 | 5.5-7.5 |
| F1000 | 3.7-5.3 |

### C. PREPARATION OF PAINT FORMULATIONS AND TEST SAMPLES

Paint formulations were made by first making a premix, while stirring at 800 rpm, containing pigment, water and additives in amounts as given in the examples. For the paint formulations containing ZnS, the pH of the premix was adjusted to alkaline (>9) by addition of a 0.25N NaOH solution.

To the premixes were added various amounts of Al₂O₃, binders and additives as is given in the respective examples.

The paint formulations were painted on 40 cm² polyethylene foil at a wet thickness of 400 micrometers. After drying at room temperature for 24 hours, the coating thickness was 150 to 180 micrometers.

The properties the coated paints were measured according to the methods described above.

### D. EXAMPLES

Note: in the following tables, for those components originally supplied in water: weight % refers to the weight % of solid and weight % of water represents total content of water composition. Dry volume % refers to volume % of a solid component based on total solid content.

### Example 1 and Comparative Example C-1

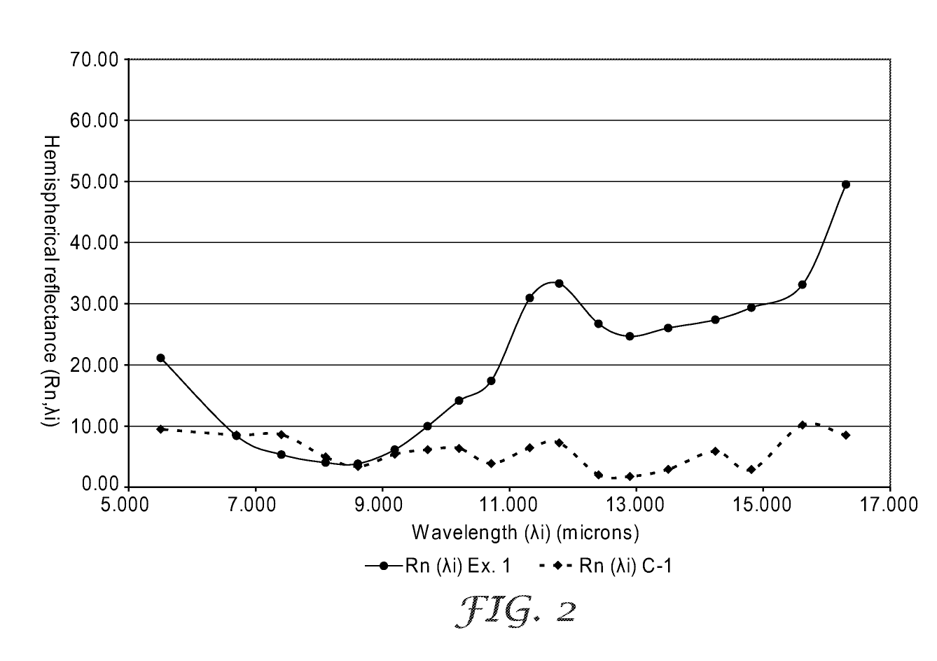

In example 1 a white paint formulation comprising ZnS and Al₂O₃ F280, was made starting from a premix of 49.8% ZnS, 49.8% water, 0.2% Defoamer and 0.2% W/D agent 1 (the percent of the defoamer and wetting/dispersing agent as taken from bottle including the liquid content of product). The pH of the premix was adjusted to 9.6 using a 0.25N NaOH solution. To this premix were added Al₂O₃ F280, binder and additives in amounts as given in table 3. A paint formulation was obtained containing 15% dry volume ZnS, 55% dry volume Al₂O₃ and 30% dry volume binder plus additives. As comparative example C-1 an interior white paint formulation typically as known in the art, was made with TiO₂. A premix was made containing 66.3% TiO₂, 33.15% water, 0.33% W/D agent 2 and 0.21% Defoamer (the percent of the defoamer and wetting/dispersing agent as taken from bottle including the liquid content of product). A second premix was made containing 19.9% water, 79.68% CaCO₃ and 0.4% W/D agent 2 (the percent of the wetting/dispersing agent as taken from bottle including the liquid content of product). The two premixes were blended together with additional binders and additives, as is given in table 3. Comparative example C-1 contained 15% dry volume TiO₂, 45% dry volume CaCO₃ and 40% dry volume binder and additives. The hemispherical reflectance of the paint formulations was measured according to the general procedure outlined above. The results are represented in FIG. 2. The total hemispherical reflectance (Rₙ) is given in table 3.

TABLE 3
Composition and total hemispherical reflectance of white paints

| | | | | | | | | | | |
|---|---|---|---|---|---|---|---|---|---|---|
| | | | | | De- | | | | | |
| ZnS | TiO₂ | Al₂O₃ | CaCO₃ | Binder 1 | foamer | T/L | W/D-1 | W/D-2 | water | Rn |

Weight %

| | | | | | | | | | | | |
|---|---|---|---|---|---|---|---|---|---|---|---|
| Ex 1 | 13.65 | 0 | 46.98 | 0 | 7.03 | 0.02 | 0.18 | 0.10 | 0 | 32.04 | 20.63 |
| C-1 | 0 | 16.25 | 0 | 32.10 | 11.56 | 0.03 | 0.36 | 0 | 0.08 | 39.63 | 5.81 |

Dry volume %

| | ZnS | TiO₂ | Al₂O₃ | CaCO₃ | Binder and additives | Rn |
|---|---|---|---|---|---|---|
| Ex 1 | 15 | 0 | 55 | 0 | 30 | 20.63 |
| C-1 | 0 | 15 | 0 | 45 | 40 | 5.81 |

### Examples 2 to 4

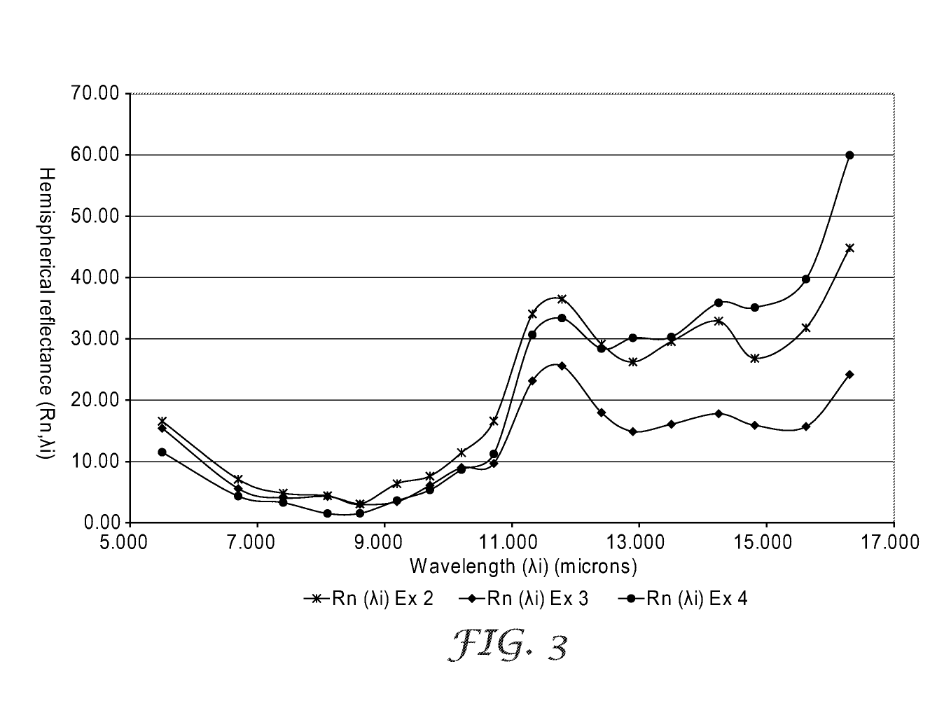

In examples 2 and 3 the hemispherical reflectance of paint formulations comprising Al₂O₃ (60% dry volume) in combination with ZnS (10% dry volume) or TiO₂ (10% dry volume) were measured, and in example 4 a paint formulation having Al₂O₃ (60% dry volume) but no pigment was evaluated. All paint formulations were made with Al₂O₃ grade F240. The composition of the different paint formulations and the total hemispherical reflectance are given in table 4. FIG. 3 represents the hemispherical reflectance spectrum of the paints.

TABLE 4
Composition and total hemispherical reflectance of paint formulations
having different white pigments or no pigment

| | | | | | | | | | |
|---|---|---|---|---|---|---|---|---|---|
| | | | Al₂O₃ | | | | | | |
| Ex | ZnS | TiO₂ | F240 | Binder 1 | Defoamer | T/L | W/D-2 | Water | Rn |

Weight %

| | | | | | | | | | |
|---|---|---|---|---|---|---|---|---|---|
| Ex. 2 | 10.17 | 0 | 57.30 | 7.87 | 0.01 | 0.21 | 0.09 | 24.35 | 20.55 |
| Ex. 3 | 0 | 9.83 | 57.52 | 7.90 | 0.01 | 0.21 | 0.09 | 24.45 | 12.88 |
| Ex. 4 | 0 | 0 | 61.91 | 11.45 | 0.01 | 0.22 | 0.08 | 26.32 | 20.81 |

Dry volume %

| | | | | | | | | | |
|---|---|---|---|---|---|---|---|---|---|
| Ex. 2 | 10 | 0 | 60 | 29 | 0.05 | 0.70 | 0.25 | / | 20.55 |
| Ex. 3 | 0 | 10 | 60 | 29 | 0.05 | 0.70 | 0.25 | / | 12.88 |
| Ex. 4 | 0 | 0 | 60 | 39.04 | 0.05 | 0.70 | 0.21 | / | 20.81 |

### Examples 5 to 8

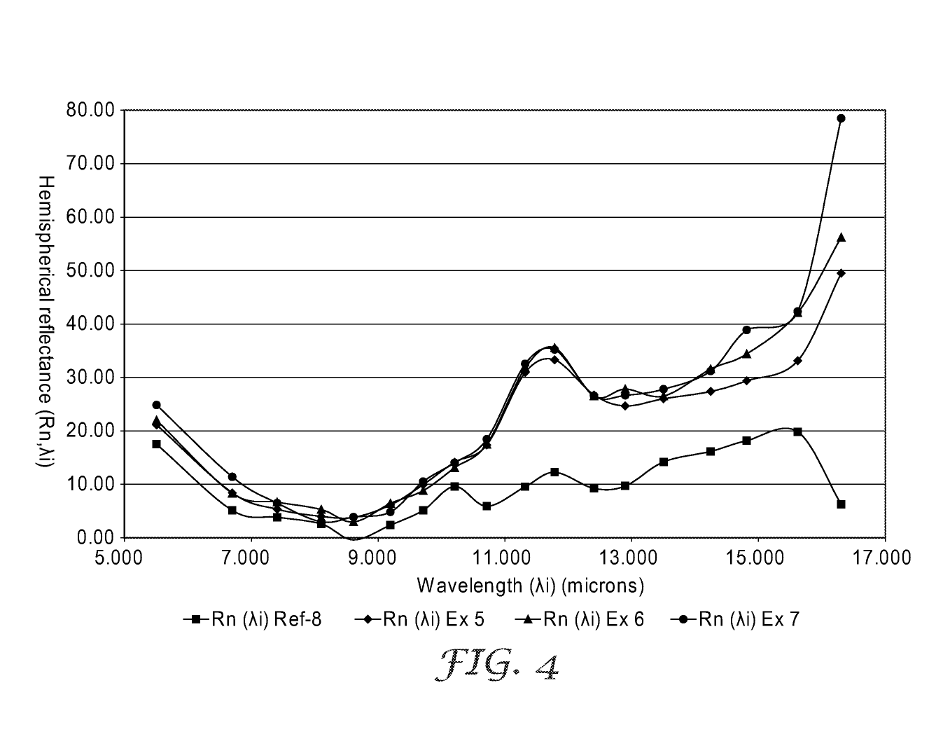

In examples 5 to 8, paint formulations were made containing different FEPA grit sizes of Al₂O₃, F280, F320, F360 and F1000, respectively. The example 8 including F1000 Al₂O₃ is a reference example. All paint formulations had 15% dry volume of ZnS, 55% dry volume of Al₂O₃ and 30% dry volume of binder and additives. All paints contained 67.97% solids (13.65 wt % ZnS, 46.98 wt % Al₂O₃, 7.03 wt % Binder 1, 0.1 wt % W/D agent 1, 0.02 wt % Defoamer and 0.18 wt % T/L agent) and 32.03% water The hemispherical reflectance of the paints was measured according to the general procedure outlined above and is represented in FIG. 4. The total hemispherical reflectance is given in table 5.

TABLE 5
Composition of paints containing different grades of Al₂O₃

| Example | Al₂O₃ FEPA grit | Rₙ |
|---|---|---|
| 5 | F280 | 20.63 |
| 6 | F320 | 22.42 |
| 7 | F360 | 24.28 |
| Ref-8 | F1000 | 9.27 |

### Examples 9 to 13

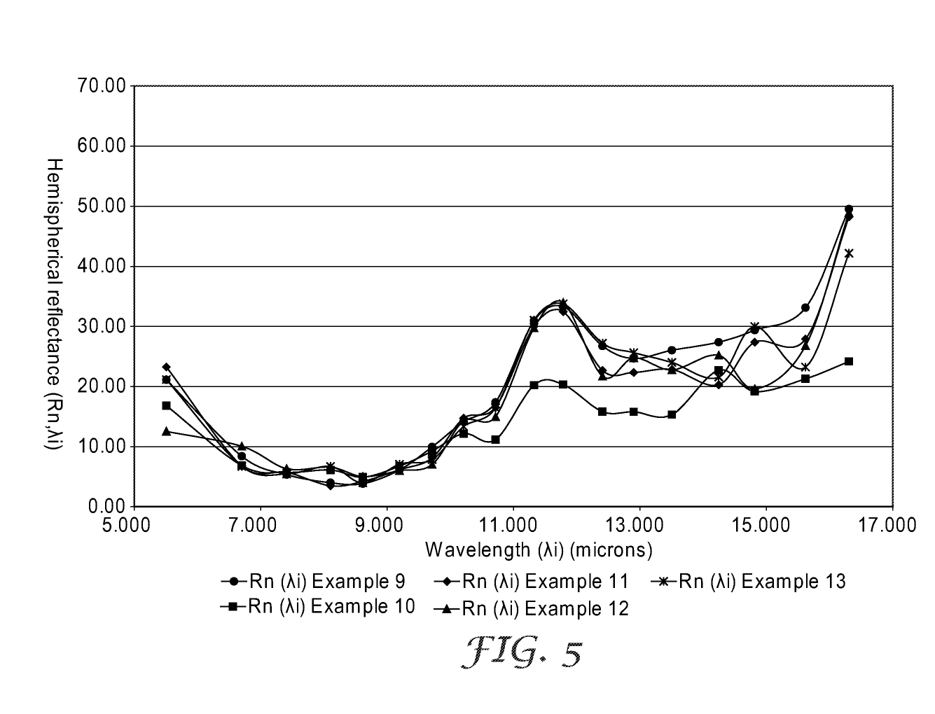

In examples 9 to 13 paint formulations were made comprising different binders. Paint formulations were made having a final composition of 15 dry vol % ZnS; 55 dry vol % Al₂O₃ F280; 0.25 dry vol % W/D agent 1; 0.7 dry vol % T/L agent; 0.1 dry vol % Defoamer; and 28.95 dry vol % of different binders (binder 1 to 5 respectively). The hemispherical reflectance of the paints as measured according to the general procedure is represented in FIG. 5. The composition of the paints (in terms of weight % of components) and their total hemispherical reflectance is given in table 6.

TABLE 6
Composition and total hemispherical reflectance
of white paints comprising various binders

| | | | | | | | | |
|---|---|---|---|---|---|---|---|---|
| | | Al₂O₃ | | | | | | |
| Ex | ZnS | F280 | Binder | Defoamer | T/L | W/D-1 | Water | Rn |

Weight %

| | | | | | | | | |
|---|---|---|---|---|---|---|---|---|
| Ex 9 | 13.65 | 46.98 | (Binder 1) 7.03 | 0.02 | 0.18 | 0.096 | 32.03 | 20.12 |
| Ex 10 | 13.63 | 46.92 | (Binder 2) 7.16 | 0.02 | 0.18 | 0.096 | 31.99 | 14.14 |
| Ex 11 | 13.71 | 47.20 | (Binder 3) 6.60 | 0.02 | 0.18 | 0.097 | 32.19 | 19.07 |
| Ex 12 | 13.68 | 47.10 | (Binder 4) 6.81 | 0.02 | 0.18 | 0.096 | 32.11 | 18.68 |
| Ex 13 | 13.67 | 47.08 | (Binder 5) 6.85 | 0.02 | 0.18 | 0.096 | 32.10 | 19.30 |

### Examples 14 to 17

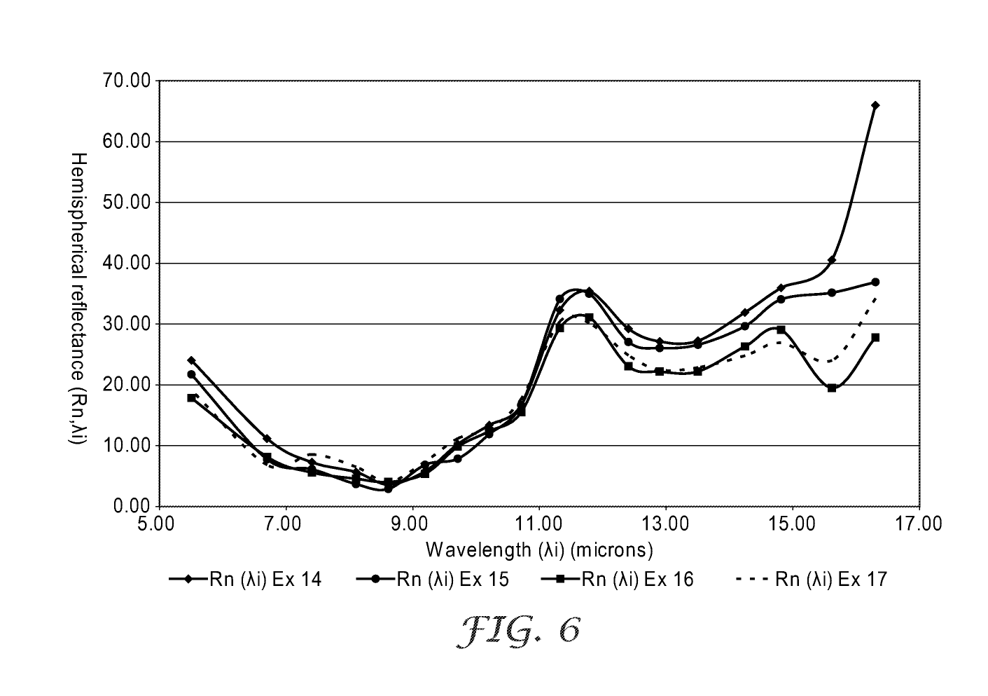

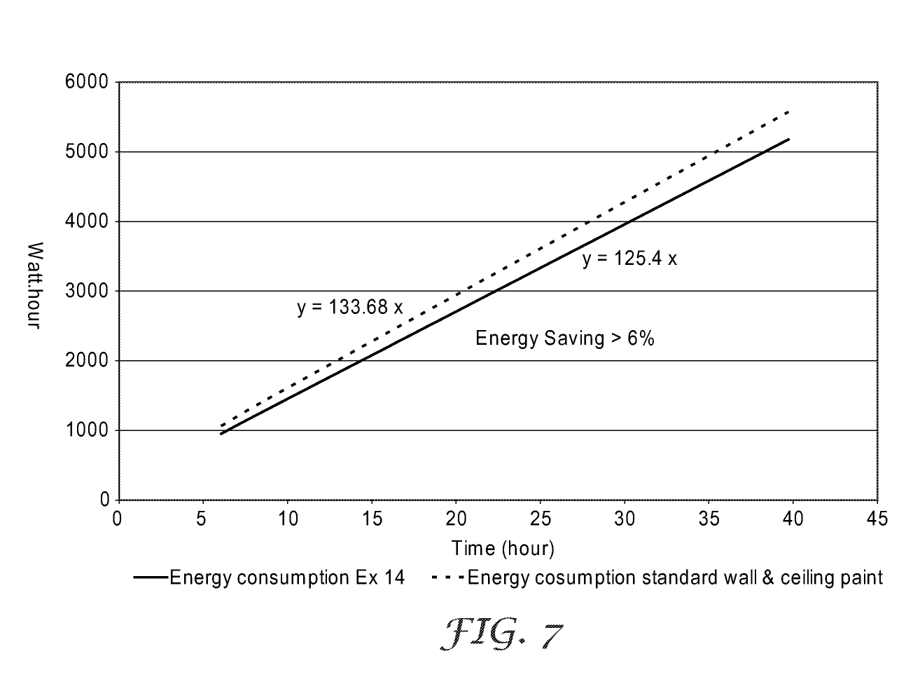

In examples 14 to 17 paint formulations were made containing between 9.1 and 18.2% by weight of ZnS, between 42.6 and 51.4% by weight of Al₂O₃ F280, between 4.3 and 10.1% by weight of binder 1, and additives as is given in table 7. The hemispherical reflectance was measured according to the procedure as outlined above. The results are reflected in FIG. 6. The total hemispherical reflectance Rₙ is given in table 7. The whiteness of examples 14 and 15 was evaluated according to the procedure outlined above. The results are given in table 8. The actual energy saving obtained with the paint of example 14 was determined according to the method as described above. A comparison was made between the energy consumption of the paint of example 14 with the energy consumption of a white standard wall and ceiling paint, obtained under the trade designation DULUX from ICI Paints Deco France S.A. The energy consumption as a function of time is represented in FIG. 7. From the slopes an energy saving of 6% was calculated according to the testing procedure described above.

TABLE 7
Composition and total hemispherical reflectance of two white paints

| | | | | | | | | |
|---|---|---|---|---|---|---|---|---|
| | | Al₂O₃ | | | | | | |
| Ex | ZnS | F280 | Binder 1 | W/D-1 | T/L | Defoamer | Water | Rₙ |

Weight %

| | | | | | | | | |
|---|---|---|---|---|---|---|---|---|
| Ex. 14 | 17.1 | 48.2 | 4.32 | 0.10 | 0.17 | 0.02 | 30.11 | 23.52 |
| Ex. 15 | 9.1 | 51.4 | 7.05 | 0.10 | 0.18 | 0.02 | 32.13 | 20.55 |
| Ex. 16 | 9.7 | 45.6 | 10.11 | 0.09 | 0.20 | 0.02 | 34.23 | 17.42 |
| Ex. 17 | 18.2 | 42.6 | 7.01 | 0.10 | 0.18 | 0.02 | 31.95 | 18.61 |

Dry volume %

| | | | | | | | | |
|---|---|---|---|---|---|---|---|---|
| Ex 14 | 20 | 60 | 18.92 | 0.28 | 0.70 | 0.10 | / | 23.52 |
| Ex 15 | 10 | 60 | 28.95 | 0.25 | 0.70 | 0.10 | / | 20.55 |
| Ex 16 | 10 | 50 | 38.99 | 0.21 | 0.70 | 0.10 | / | 17.42 |
| Ex 17 | 20 | 50 | 28.95 | 0.25 | 0.70 | 0.10 | / | 18.61 |

TABLE 8
Whiteness of paint formulations comprising ZnS and Al₂O₃

| | Ex 14 | Ex 15 |
|---|---|---|
| L*a*b* Black Substrate | 89.9 | 83.7 |
| L*a*b* White Substrate | 94.2 | 93.9 |
| Opacity % | 95.5 | 89.1 |

1. A paint composition comprising white alumina having a median particle size of at least 5.5 micrometers.

2-4. (canceled)

5. A composition according to claim 1, wherein the white alumina has a median particle size of at most 80 micrometers.

6-7. (canceled)

8. A composition according to claim 1, wherein the concentration of white alumina is at most 90 weight percent based on total solid content.

9-10. (canceled)

11. A composition according to claim 1, wherein the concentration of white alumina is at least 35 weight percent based on total solid content.

12-14. (canceled)

15. A composition according to claim 1, wherein the white alumina is white corundum.

16. A composition according to claim 15, wherein the white corundum is essentially free or free of chromium oxide, manganese oxide and titanium dioxide.

17. A composition according to claim 15, wherein the white corundum is of a purity corresponding to at least 95 wt % Al₂O₃.

18. A composition according to claim 17, wherein the white corundum is of a purity corresponding to at least 95 wt % Al₂O₃; at most 2 wt % Na₂O; at most 2 wt % SiO₂; at most 0.5 wt % Fe₂O₃; and at most 0.4 wt % collectively CaO and MgO.

19-22. (canceled)

23. A composition according to claim 15, wherein the white corundum is essentially free or free of antimony oxide, bismuth oxide, boron oxide, cobalt oxide, gallium oxide, indium oxide, lanthanum oxide, lithium oxide, molybdenum oxide, neodymium oxide, nickel oxide, niobium oxide, tin oxide, vanadium oxide and zinc oxide.

24. A composition according to claim 15, wherein the white corundum is white fused corundum.

25. A composition according to claim 1, wherein the composition further comprises a white pigment selected from the group consisting of zinc sulfide, lithopone, zinc oxide, zirconium (IV) oxide, bismuth oxychloride, white lead, and mixtures thereof.

26. A composition according to claim 25, wherein the white pigment is zinc sulfide.

27-33. (canceled)

34. A composition according to claim 1, wherein the composition further comprises at least one colored pigment.

35. A composition according to claim 34, wherein said at least one colored pigment is colored metal oxide pigment.

36. A composition according to claim 34, wherein said at least colored pigment is an infrared reflective colored pigment.

37-38. (canceled)

39. A composition according to claim 1 further comprising a binder, wherein the binder is a resin selected from the group consisting of acrylic resins, styrene-acrylic copolymers, styrene-(meth)acrylic acid copolymers, ethylene-vinylacetate copolymers and mixtures thereof.

40. A composition according to claim 39, wherein the binder is an acrylic resin or a mixture of acrylic resins.

41-45. (canceled)

46. A composition according to claim 1, wherein the composition is substantially free or free of elemental metal and metal alloy particulates.

47. A composition according to claim 1, wherein the composition is substantially free of titanium dioxide.

48-49. (canceled)

50. A composition according to claim 1, wherein the composition is provided in a form of a concentrate suitable for dispersion in a vehicle, the vehicle being selected from the group consisting of water, a water-based liquid and a organic-based liquid.

51. (canceled)
